(19) United States
(12) Patent Application Publication
(10) Pub. No.: US 2007/0139603 A1
(43) Pub. Date: Jun. 21, 2007

(54) Liquid crystal display device having spacer elements restricting substrate gap

(75) Inventors: Kazuya Saegusa, Enzan-shi (JP); Takeshi Yamada, Kofu-shi (JP); Jiro Izumi, Machida-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignees: KOFU CASIO CO., LTD., Chuo-shi (JP); Casio Computer Co., Ltd., Tokyo (JP)

(21) Appl. No.: 11/639,746

(22) Filed: Dec. 15, 2006

(30) Foreign Application Priority Data
Dec. 21, 2005 (JP) 2005-368831

(51) Int. Cl. G02F 1/1339

(52) U.S. Cl. 349/155; 349/153

(57) ABSTRACT

A liquid crystal display device includes a pair of substrates arranged to face each other, and electrodes respectively arranged on inner sides of the substrates, define a plurality of pixels in a display region. A sealing frame surrounds an outer side of the display region between the pair of substrates, and joins the substrates with a predetermined gap in which a liquid crystal layer is provided. A plurality of spacer elements are dispersed between the substrates and have a diameter that restricts a length of the gap between the substrates. A support layer is provided in a clearance between the display region and the sealing frame between the pair of substrates, and comes into contact with those of the spacer elements which are positioned close to the sealing frame, to support these spacer elements to prevent a deformation of the substrate.

### CROSS-REFERENCE TO RELATED APPLICATIONS

This application is based upon and claims the benefit of priority from prior Japanese Patent Application No. 2005-368831, field Dec. 21, 2005, the entire contents of which are incorporated herein by reference.

### BACKGROUND OF THE INVENTION

1. Field of the Invention

The present invention relates to a liquid crystal display device in which spacer elements that restrict a gap between a pair of substrates sandwiching a liquid crystal therebetween are dispersed and arranged.

2. Description of the Related Art

A liquid crystal display device is generally constituted of a pair of substrates having electrodes formed on opposed inner surfaces thereof, and a liquid crystal layer interposed between the pair of substrates. In this liquid crystal display device, a display failure, e.g., display unevenness occurs when a thickness of the liquid crystal layer sandwiched between the pair of substrates is not uniform. Therefore, the thickness of the liquid crystal layer (a liquid crystal layer thickness) must be uniform. Heretofore, to obtain a uniform liquid crystal layer thickness, as disclosed in Jpn. Pat. Appln. KOKAI Publication No. 136943-1996, there has been employed a method in which spherical or cylindrical spacer elements are uniformly dispersed and arranged in a surface direction as members or materials that restrict a substrate gap in which a liquid crystal is provided, in a region which is surrounded by a pair of substrates and a frame-like sealing member and to which the liquid crystal is introduced. In this case, matching a diameter of each of the spacer elements with a desired liquid crystal layer thickness allows the liquid crystal layer thickness to be stably maintained at a desired layer thickness.

In general, as regions of a liquid crystal display device where a liquid crystal is introduced, there are two regions, i.e. a display region in which a plurality of pixels are arranged and a peripheral region around this display region. Electrodes, various kinds of functional films like an alignment film as well as color filters in a color liquid crystal display device are superimposed to each other in the display region. On the other hand, various kinds of functional films or color filters are not arranged in the peripheral region, and hence a substrate outer gap in the peripheral region around the display region becomes larger than a substrate inner gap (namely a gap between the outermost films on the opposite sides of the pair of the substrates) in the display region where pixels are arranged.

Therefore, according to the method of maintaining the substrate gap (inner and outer gaps) at a desired dimension by using the spacer elements, since a particle diameter of the spacer elements is set to be equal to the substrate inner gap in the display region where pixels are arranged, the spacer elements are in a floating state in the peripheral region having the larger gap without coming into contact with both outermost sides of the substrate assemblies.

Thus, the substrate corresponding to the region where the gap is floating is apt to bend and, in particular, thicknesses of the substrates having the liquid crystal sandwiched therebetween are selected to be thin in accordance with a reduction in thickness of the liquid crystal display device. Therefore, the substrate part in the peripheral region inwardly bends, and the substrate part parallel to an outer peripheral of the display region continuous with the peripheral region bends to outwardly bulge, thereby increasing a distance of the gap (in a thickness direction of the display device) in this part. As a result, display unevenness occurs at an edge or periphery of the display region, thus deteriorating a display quality.

### BRIEF SUMMARY OF THE INVENTION

It is an object of the present invention to provide a liquid crystal display device that has a uniform substrate inner gap and reduced occurrence of display unevenness.

According to a first aspect of the present invention, there is provided a liquid crystal display device comprising:

a pair of substrates arranged to face each other;

a plurality of electrodes which are respectively arranged on inner sides of the pair of substrates, define a plurality of pixels by opposed regions thereof, and form a display region where the plurality of pixels are arranged;

a sealing frame which is arranged to surround an outer side of the display region between the pair of substrates, and joins the pair of substrates with a predetermined gap;

a plurality of spacer elements which are dispersed between the pair of substrates and have a diameter that restricts a length of the gap between the pair of substrates;

a liquid crystal layer provided in the gap surrounded by the sealing frame; and

a support layer which is provided in a clearance between the display region and the sealing frame between the pair of substrates, and comes into contact with those of the spacer elements which are positioned close to the sealing frame to support those of the spacer elements positioned close to the sealing frame to prevent a deformation of the substrate.

According to the liquid crystal display device of the present invention, a display quality without display unevenness can be obtained.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view showing a simple matrix type color liquid crystal display device as an embodiment according to the present invention;

FIG. 2 is a cross-sectional view taken along a line II-II in FIG. 1;

FIG. 3 is a view showing a comparative example with respect to the embodiment depicted in FIG. 2;

FIG. 4 is a plan view showing a simple matrix type color liquid crystal display device as a second embodiment according to the present invention; and

FIG. 5 is a plan view showing a simple matrix type color liquid crystal display device as a third embodiment of the present invention.

### DETAILED DESCRIPTION OF THE INVENTION

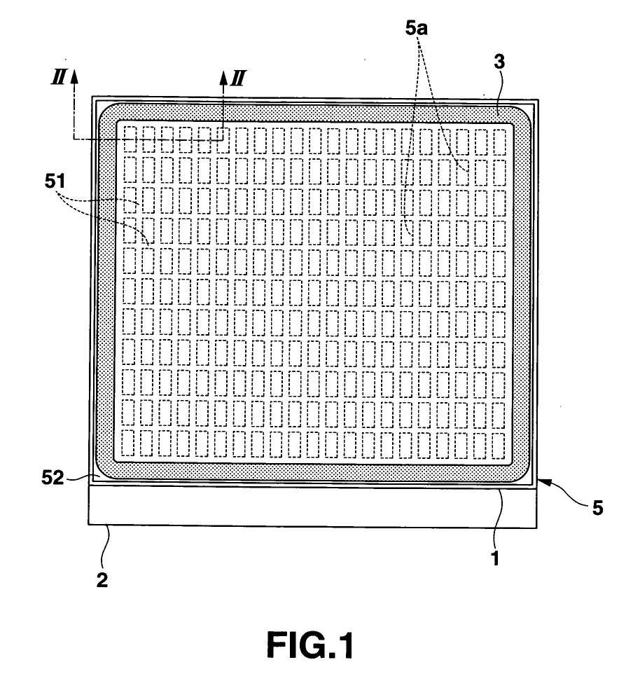

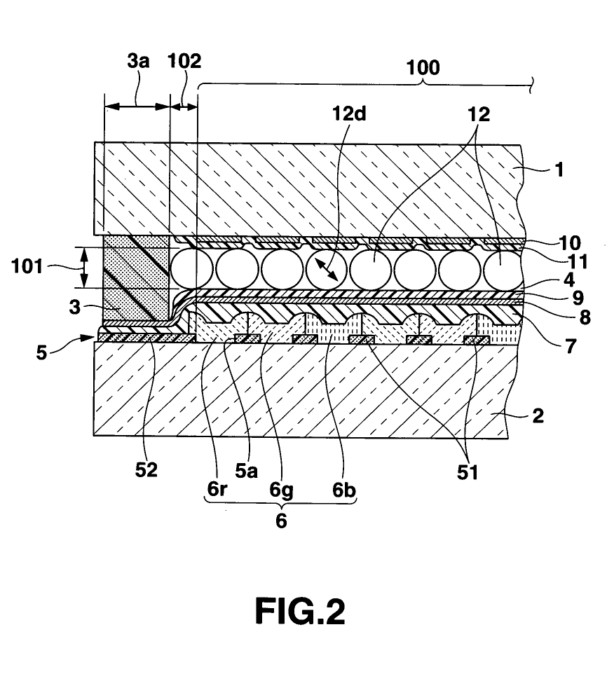

A color liquid crystal display device according to the first embodiment has, as shown in FIGS. 1 and 2, a structure in which a pair of rectangular transparent substrates 1 and 2 made of glass are bonded with a gap of a predetermined distance maintained therebetween by a frame-like sealing member 3 arranged between peripheries of these substrates. A liquid crystal 4 is sealed between respective opposed innermost sides (which will be merely referred to as inner sides thereinafter) of the glass substrates 1 and 2 surrounded by the frame-like sealing member 3.

A black matrix 5 as a light shielding film that prevents transmission of light in a part other than a part corresponding to a plurality of pixels is directly disposed on an inner surface (a surface disposed on a side of liquid crystal) of one glass substrate 2 of the pair of glass substrates 1 and 2. The black matrix 5 according to this embodiment is formed by using a resin material having a black pigment mixed in a photosensitive base resin to form a layer and patterning this layer based on photolithography. A plurality of openings Sa are formed in the black matrix 5 in a matrix form in accordance with the pixels.

The black matrix 5 includes a lattice portion 51 formed into a lalttice shape in accordance with a space between the respective pixels in a display region 100 where the pixels are arranged in a matrix form, and an outer frame portion 52 surrounding the display region 100. A film thickness of the black matrix 5 is set to be as thin as possible to assure required light shielding performance.

Respective color filters 6r, 6g, and 6b of red, green, and blue constituting a color filter array 6 are arranged in the respective openings 5a in the black matrix 5 in a predetermined order. In this embodiment, the stripe-like color filters 6r, 6g, and 6b are provided along respective columns of the openings 5a. A width of each of the color element filters 6r, 6g, and 6b on a front surface side is set to be larger than a width of the opening 5a. Therefore, the respective color element filters 6r, 6g, and 6b are disposed in such a manner that both side edges thereof on the front surface side are superimposed on the black matrix 5. Accordingly, both side edges of each of the color filters 6r, 6g, and 6b raise by an amount corresponding to the thickness of the black matrix 5, whereby the exposed surface becomes irregular. However, the thickness of the black matrix 5 is reduced as much as possible in this embodiment, thereby suppressing the raise (a height of a convex portion) of both side edges of each color filter.

A protection film 7 formed of a transparent acrylic resin that flattens an irregular surface of the color filter array 6 having the color filters 6r, 6g, and 6b arranged thereon is uniformly formed on this surface. A plurality of scanning electrodes 8 are provided on a substantially flattened surface of this protection film 7. Each scanning electrode 8 is formed by patterning a transparent electroconductive film made of ITO (Indium Tin Oxide) into a stripe form based on photolithography. Each of these scanning electrodes 8 is formed into a strip shape extending in a row direction (a direction perpendicular to an extending direction of each of the color element filters 6r, 6g, and 6b) of each opening 5a in the black matrix 5. An alignment film 9 that restricts an alignment direction of liquid crystal molecules is uniformly formed on the inner surface side of the substrate 2 to cover the plurality of scanning electrodes 8 except outer edges thereof.

On an inner surface of the other glass substrate 1, a plurality of display electrodes 10 are provided to extend in parallel in directions perpendicular to the scanning electrodes 8 (the extending directions of the color element filters 6r, 6g, and 6b). Each of these display electrodes 10 is also formed by patterning a transparent electroconductive film made of ITO (Indium Tin Oxide) into a stripe shape based on photolithography. An alignment film 11 is uniformly formed to cover these display electrodes 10 except the outer edges thereof.

Both the thus configured glass substrates 1 and 2 are bonded by using the sealing frame 3 in such a manner that their surfaces having the respective electrodes formed thereof face each other. Spacer elements or spacers 12 formed of many spherical particles are uniformly dispersed and arranged between these glass substrates 1 and 2 along a plan direction. The spacer elements 12 are arranged as substrate gap restricting members that restrict an inner gap 101 where the liquid crystal 4 is sandwiched between the glass substrates 1 and 2, and an average value of a particle diameter 12d thereof is matched with the inner gap 101 that allows acquisition of a desired liquid crystal layer thickness. Further, a support layer that comes into contact with the outermost spacer elements (contactingspacer elements positioned near the sealing film 3) 12 to support these contacting spacer elements 12 is formed between the display region and the sealing frame 3 by using at least one of parts of films such as light shielding film and the color filter array.

Here, in the liquid crystal display device according to this embodiment, an outer frame portion 52 of the light shielding film 5, the color filter array 6, the protection film 7, the electrodes 8, and the alignment film 9 provided thereon form the support layer between the display region 100 and the sealing frame 3. Furthermore, a gap or clearance 102 between an outer side of the display region 100 having the plurality of pixels arranged therein and the sealing frame 3 is set to be smaller than the average value of the diameter 12d of the spacer elements 12. As a result, there are no spacer elements 12 that are in a floating state without coming into contact with the inner sides of the glass substrates 1 and 2. Consequently, a substantially entire region surrounded by the sealing frame 3 of the glass substrates 1 and 2 is supported by the spacer elements 12, thereby obtaining a uniform substrate gap in the display region.

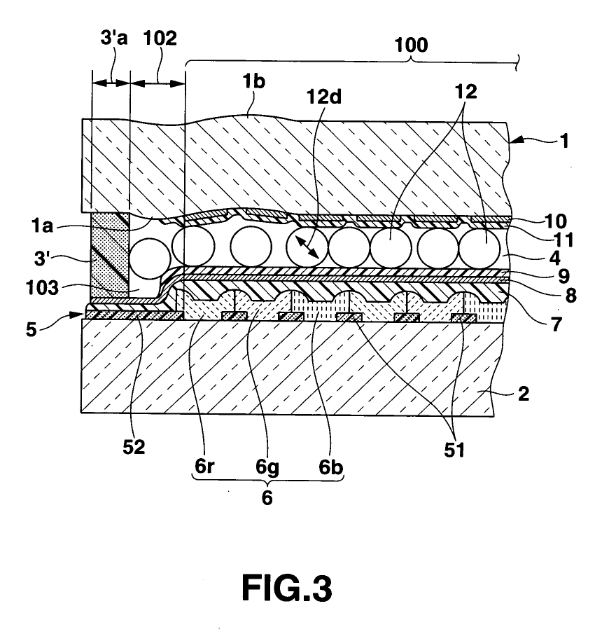

According to a comparative example shown in FIG. 3, the clearance 102 between the display region 100 and a sealing frame 3′ is set to be larger than the average value of the particle diameter 12d of the spacer elements 12. When such a setting is adopted, the spacer elements 12 fall in or are about to fall in a concave portion 103 formed with a longitudinal direction thereof being parallel with an inner wall surface of the sealing frame 3′, and a region where the glass substrates 1 and 2 are not supported from the inside is present in the region corresponding to the clearance 102. As a result, of the glass substrates 1 and 2 each having a reduced wall thickness, the first glass substrate 1 positioned on the upper side is bent at a portion 1a thereof, and an edge 1b of the display region 100 adjacent to this concave portion raises, and the liquid crystal layer thickness at this portion becomes larger than a desired thickness. The portion having the large liquid crystal layer thickness produced along the edge of this display region 100 provokes display unevenness, thereby deteriorating a display quality.

On the other hand, in the liquid crystal display device according to the first embodiment, a width 3a of the sealing frame 3 is increased to be larger than a width 3′ a of the sealing frame 3′ in the comparative example so that the clearance 102 between the display region 100 and the sealing frame 3 becomes smaller than the average value of the particle diameter or width 12d of the spacer elements 12. At least a part of the outer frame portion 52 of the light shielding film 5, the outer side portion of the color filter array 6, and parts of the films 7, 8, and 9 provided thereon form the support layer of the contacting spacer elements 12. Therefore, a range supported by the sealing frame 3 of the glass substrates 1 and 2 is expanded, and a rim region of the display region 100 that is not supported from the inside by the spacer elements 12 can be substantially eliminated. As a result, the inner gap in the display region of glass substrates 1 and 2 becomes uniform, whereby an excellent display quality can be stably obtained without display unevenness.

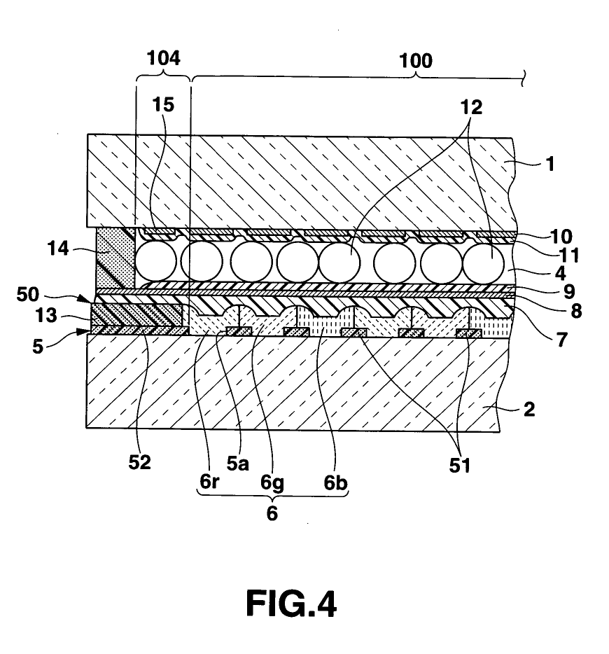

A color liquid crystal display device as a second embodiment according to the present invention will now be explained with reference to FIG. 4. It is to be noted that like reference numerals denote the same constituent elements as those in the first embodiment, thereby omitting a detailed explanation thereof.

In a color liquid crystal display device according to this embodiment, a black mask 13 formed into a frame-like shape by using the same material as a black matrix 5 based on photolithography is superimposed on an outer frame portion 52 of the black matrix 5 that is the same as that in the first embodiment. That is, a rectangular frame-like light shielding film 50 arranged at a part corresponding to an outer peripheral region 104 around a display region 100 and a sealing frame 14 (a part positioned below the sealing frame 14) is constituted of an outer frame portion 52 that is formed of a lattice-like light shielding film arranged between pixels in the display region and has the same thickness as that of a lattice portion 51, and the black mask 13 having a film thickness that is substantially equal to that of a color filter 6 or, more specifically, a film thickness of the lattice portion 51 of the color filter 6 or an upper part of the outer frame portion 52. Therefore, a thickness of the frame-like light shielding film 50 is formed to be a thickness that is substantially equal to a thickness obtained by superimposing the lattice portion 51 of the display region 100 and the color filter 6.

When the frame-like light shielding film 50 arranged in the peripheral region 104 between the display region 100 and the sealing frame 14 is formed into a double layer structure (the black matrix 5 and the black mask 13 are sequentially formed by using the same material, and hence they are regarded as the same layer) in this manner, the frame-like light shielding film 50 can be accurately formed with a desired film thickness based on photolithography without a reduction in an accuracy of the film thickness caused due to an increase in thickness of the film to be formed.

In the peripheral region 104 between the display region 100 and the sealing frame 14 on a first glass substrate 1, a dummy electrode or electrodes 15 that are not used for display are simultaneously formed with display electrodes 10 by using the same material as that of these electrodes 10. The dummy electrode 15 is provided to uniform a substrate gap.

When manufacturing the color liquid crystal display device according to this embodiment, the black matrix 5 is formed on a surface of a second glass substrate 2 that faces the first substrate 1 based on photolithography, and then respective color element filters 6r, 6g, and 6b are formed in accordance with respective openings 5a. Thereafter, the black mask 13 is superimposed and arranged on the outer frame portion 52 of the light shielding film 5 by a photolithography. Moreover, a protection film 7 is formed to adhere to irregular surfaces of the respective color element filters 6r, 6g, and 6b, and an upper surface of the black mask 13 in such a manner that a surface of the protection film 7 becomes flat and uniform. Scanning electrodes 8 and an alignment film 9 are sequentially superimposed on the thus obtained flat surface.

In the color liquid crystal display device according to this embodiment having the above-explained structure, a second light shielding film formed of the frame-like light shielding film 50 having a thickness substantially equal to a maximum layer thickness of the color filter array 6 is provided on an outer side of an inner edge of the outer frame portion 52 of the first light shielding film formed of the black mask 5 that prevents transmission of light around the display region 100. The outer frame portion 52 and the frame-like light shielding film 50 form a support layer. Therefore, a liquid crystal layer thickness of a substrate gap where a liquid crystal is sandwiched between the substrates becomes constantly fixed in an entire liquid crystal introducing space. Accordingly, occurrence of bending of the substrate is more assuredly avoided, and a high display quality having no display unevenness can be more stably obtained.

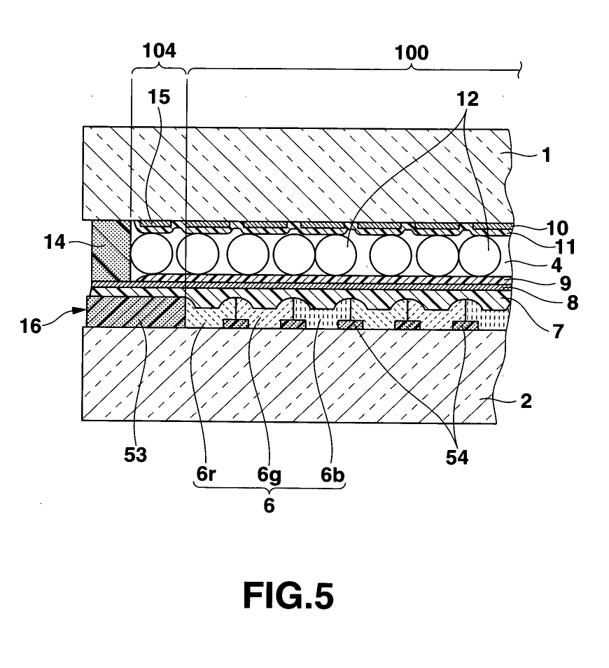

A third embodiment according to the present invention will now be described with reference to FIG. 5.

In a color liquid crystal display device according to this embodiment, the outer frame portion 52 of the black matrix 5 and the black mask 13 which constitute the frame-like light shielding film 50 according to the second embodiment shown in FIG. 4 are collectively or integrally formed in the same process. Like reference numerals denote the same constituent elements as those in the second embodiment, thereby omitting an explanation thereof.

An entire black matrix 16 is constituted of a single layer collectively formed based on photolithography, and a film thickness of an outer frame portion 53 of a frame-like light shielding film 50 is set to be larger than a film thickness of a lattice portion 54 as a light shielding film for a display region 100 by an amount corresponding to a substantial thickness of a color filter 6. Any other structures are the same as those in the embodiment depicted in FIG. 4.

In order to manufacture the black matrix 16, a spin coat method using a photosensitive black negative resist material is utilized to apply and form a resist film having a uniform film thickness on a glass substrate 2, and this resist film is irradiated with light through a photomask. The photomask used in this process is a member in which openings corresponding to the lattice portion 54 are formed of a plurality of small-width slits that are not greater than a resolution of irradiation light, and this photomask is set with a predetermined distance from a resist film surface. It is to be noted that a large opening corresponding to the outer frame portion 53 is usually a single rectangular opening.

When the resist film is irradiated with light through the photomask in this state, the light is diffracted at the time of being transmitted through the small-width slits of the photomask, and the light transmitted through the respective slits is scattered and reaches the resist surface. Therefore, a light intensity per unit area is small. On the other hand, the light transmitted through the opening corresponding to the outer frame portion 53 reaches the resist film surface without being substantially scattered. As a result, in the negative resist film of the lattice portion 54, a degree of hardening obtained by exposure to the light is relatively reduced due to insufficient irradiation of the light, and the film thickness of this film becomes smaller than that of the outer frame portion 53. A difference in film thickness between these portions can be optimally controlled by adjusting, e.g., a width of each small slit or a distance of the photomask from the resist film surface.

As described above, in the color liquid crystal display device according to this embodiment, the film thickness of the outer frame portion 53 positioned in the peripheral region 104 is set to be larger than the film thickness of the lattice portion 54 placed in the display region 100 by an mount substantially equal to the thickness of the color filter 6, and the black matrix 16 is collectively formed based on photolithography, whereby the entire structure is formed of a single layer. Therefore, the substrates are uniformly supported by the gap particles in the entire liquid crystal introducing region, and the substrates inner gap is thereby maintained constant with a desired size. Therefore, the color liquid crystal display device in which occurrence of display unevenness due to bending of the substrates is assuredly eliminated can be readily manufactured with the reduced number of manufacturing steps.

The present invention is not restricted to the foregoing embodiments.

For example, the present invention is particularly effective for the color liquid crystal display device in the first embodiment. However, the present invention is not restricted thereto, and it can be effectively applied to a black-and-white liquid crystal display device to which no color filter is provided. In this case, the support portion may be constituted of the outer frame 53 of the black matrix 16 alone like the embodiment depicted in FIG. 5, or it may be formed of at least one of functional films, e.g., the protection film 7, the electrodes 8, and the alignment film 9.

Although spherical particles are used as the spacer elements that restrict the substrate gap in the foregoing embodiments, other shapes such as a cylindrical shape may be adopted. The present invention can be effectively applied to, e.g., a liquid crystal display device in which cylindrical particles obtained by cutting a transparent material, e.g., a glass fiber short are used as the spacer elements.

According to the first embodiment depicted in FIG. 2, the sealing frame 3 is widely formed to reduce the clearance between the display region 100 and the sealing frame 3. However, it is possible to adopt a structure in which a position of the sealing frame is shifted closer to the display region 100 without changing the width of the sealing material, i.e., the entire sealing material is reduced in size. Contrarily or simultaneously, the display region may be increased in size.

According to the third embodiment depicted in FIG. 5, the outer frame portion 53 arranged in the peripheral region 104 and the lattice portion 54 arranged in the display region 100 are collectively formed in the same process. However, it is possible to adopt a structure in which the outer frame portion 52 and the lattice portion 51 are formed into respective single layers in different processes.

Additionally, it is needless to say that the present invention is not restricted to the simple matrix type liquid crystal element and it can be extensively applied to other liquid crystal display devices of, e.g., an active matrix type other than the simple matrix type.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display device comprising:
a pair of substrates arranged to face each other;
a plurality of electrodes which are respectively arranged on inner sides of the pair of substrates, define a plurality of pixels by opposed regions thereof, and form a display region where the plurality of pixels are arranged;
a sealing frame which is arranged to surround an outer side of the display region between the pair of substrates, and joins the pair of substrates with a predetermined gap;
a plurality of spacer elements which are dispersed between the pair of substrates and have a diameter that restricts a length of the gap between the pair of substrates;
a liquid crystal layer provided in the gap surrounded by the sealing frame; and
a support layer which is provided in a clearance between the display region and the sealing frame between the pair of substrates, and comes into contact with those of the spacer elements which are positioned close to the sealing frame, to support those of the spacer elements which are positioned close to the sealing frame to prevent a deformation of the substrate.

2. The liquid crystal display device according to claim 1,
further comprising a light shielding film that prevents transmission of light between the respective pixels and around the display region, and a color filter array formed of a plurality of color filters that selectively transmit light having a specific wavelength through the respective pixels,
the support layer including at least one of parts of the light shielding film and the color filter array.

3. The liquid crystal display device according to claim 2,
wherein the plurality of pixels are arranged in a matrix form, and the support layer includes a laminated film formed of the parts of the light shield film and the color filter array.

4. The liquid crystal display device according to claim 1,
wherein the clearance between the display region and the sealing frame has a width distance smaller than an average value of a diameter of the spacer elements.

5. The liquid crystal display device according to claim 4,
further comprising a light shielding film that prevents transmission of light between the respective pixels and around the display region, and a color filter array formed of a plurality of color filters that selectively transmit light having a specific wavelength through the respective pixels,
the support layer including a laminated film formed of parts of the light shielding film and the color filter array.

6. The liquid crystal display device according to claim 5, further comprising a protection film that is formed on the color filter array in at least the display region and has a flat surface,
the laminated film being formed of the parts of both the light shielding film, protection film, and the color filter array.

7. The liquid crystal display device according to claim 5,
wherein the light shielding film includes a lattice portion formed into a lattice shape in accordance with a space between the respective pixels in the display region, and an outer frame portion that surrounds the display region, a distance between an inner edge of the outer frame portion and the sealing frame being set to a distance smaller than an average value of a diameter of the spacer elements.

8. The liquid crystal display device according to claim 7,
wherein the light shielding film includes a first light shielding film part that prevents transmission of light around the display region and a second light shielding film part that is arranged on an outer side of the inner edge of the outer frame portion, constitutes the outer frame portion of the light shielding film and has a thickness substantially equal to a layer thickness of the color filter array, and
the support layer has a laminated structure formed of the outer frame portion of the first light shielding film and the second light shielding film.

9. The liquid crystal display device according to claim 7,
wherein the light shielding film has an outer frame portion formed with a thickness substantially equal to a layer thickness of the laminated structure including the lattice portion formed in the display region and the color filter array.

10. The liquid crystal display device according to claim 9, further comprising at least one dummy electrode that is formed on said one substrate facing the other substrate having the light shielding film formed thereon, and positioned between the display region and the sealing frame.
